(19) United States
(12) Patent Application Publication
(10) Pub. No.: US 2013/0054481 A1
(43) Pub. Date: Feb. 28, 2013

(54) SYSTEM AND METHOD FOR SHARING, ANALYZING AND CONSOLIDATING MEDICAL DATA IN A SOCIAL NETWORK

(71) Applicant: Sujatha Raviprasad Upadhyaya, Bangalore (IN)

(72) Inventor: Sujatha Raviprasad Upadhyaya, Bangalore (IN)

(73) Assignee: Infosys Limited, Bangalore (IN)

(21) Appl. No.: 13/328,824

(22) Filed: Dec. 16, 2011

(30) Foreign Application Priority Data
Aug. 23, 2011 (IN) 2858/CHE/2011

(51) Int. Cl. G06Q 99/00

(52) U.S. Cl. 705/319

(57) ABSTRACT

This disclosure describes a system and methodology for sharing, analyzing and consolidating medical data on social networks in a well secured manner. It allows patients, medical professionals, and caregivers participate in an open media without the fear of their personal information being compromised. At the same time, it allows each user to benefit from analysis of clinical information available on network. It facilitates sharing of information with chosen contacts in a specific manner such that the visibility of information can be configured on individual basis. More importantly, it facilitates the creation of authentic source of medical database at the backend that can be made available for research and analytics on preserving privacy.

### FIELD

The disclosure relates generally to clinical data analysis on a social networking service and, in particular, to a system and method for sharing, analyzing and consolidating medical data in a social network.

### BACKGROUND

Presently, Medical Social Networks are seen as a means to connect to people with similar health concerns. By using this platform patients can get information about the other patients having same medical conditions and doctors can also use this platform to communicate with other doctors and patients. Most medical social networks are meant for the doctors or professionals or physicians to connect with others including unknown persons on professional and personal front.

One problem with such medical social networking sites is that they are not seen as a platform to share a clinical data. Clinical data are regarded most sensitive data and handling of this data requires utmost care. At the moment no methodology ensures that patient or clinical data are shared safely on the medical social networks. Social networks are deemed to be an unsafe platform to share personal information.

Another problem with such medical social networking sites is that the information provided by its members is not wholly trusted. One has to ensure the Authenticity of its members. It is possible that people with vested interest become a part of the network posing as medical professionals or patients, trying to promote products and drugs. Few social networks only for physicians allows only verified US Doctors to connect with each other. However we as of today, we do not have a medical social network that connect verified patients, doctors and caretakers coming together at one platform.

Yet another problem with such medical social networking sites is that they do not provide a platform to do medical research. Like any other form of research, clinical research is also driven by the availability of authentic, large clinical data. Practitioners and researchers today are restricted to the data they have their hands on which is neither of good quantity nor of good quality. As of today, we have no means of creating a global database that gathers information from patients across the globe and maintained for use of researchers, patients and professionals, simultaneously safeguards the interest of patients.

Still another problem with such medical social networking sites is that they do not provide any tool to connect people in emergency situations.

In view of the foregoing discussion, there is a need for designing a social network platform that ensures all users of the network including professionals, patients and caretakers are verified, used to share clinical data, prevents the misuse of personal information, gathers medical data across the globe in a secured and structured manner and make it available to patients or professionals or researchers for better understanding of diseases and treatments, used as tool for connecting to people in emergency situations.

### SUMMARY

The shortcomings of the prior art are overcome and additional advantages are provided through the provision of a method and system as described in the description.

The present disclosure solves the limitations of existing techniques by providing a system and method for sharing, analyzing and consolidating medical data in a social network.

In one embodiment, the disclosure provides a system for sharing, analyzing and consolidating medical data in a social network. The system includes an authentication module which is configured to verify one or more data associated with one or more participants applied to become a member in the medical social network. The system also includes an access control configuration means by which the accessibility of data associated with a member of the social network is restricted. The system provides a platform for doing statistical analysis of data available in the social network. The system further provides an emergency service facility to its members comprising: listing names of one or more medical professionals or caregivers to be contacted in case of an emergency, sending an alert message to the medical professionals or care givers.

In one embodiment, the disclosure provides a method for sharing, analyzing and consolidating medical data in a social network. The method includes receiving request to become a member of the social network and classifying the participants as patients, medical professionals or caregivers based on one or more data entered by the participants. Further, sending the data entered by the participants to a medical professional registration body for verification of a medical professional, to a certified medical professionals for verification of a patient and to one or more member patients or one or more member medical professionals in case of a caregiver. The method further includes restricting accessibility of data associated with a member of the medical social network to one or more contacts in the medical social network based on an access control configuration of the member data. The method also includes analysing a plurality of medical data available at the medical social network using one or more statistical parameters by one or more researchers. The method further includes masking one or more personal information of one or more members of the social network in one or more query results. The method also includes sending an alert message to one or more medical professionals in case of an emergency.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which

FIG. 1 illustrates an exemplary environment of an online social network;

FIG. 2 depicts an exemplary environment of an online social network along with various modules for sharing and analyzing medical data in the social network;

FIG. 3 is a flowchart for sharing, analyzing and consolidating medical data in a social network, in accordance with an embodiment of the present invention;

FIG. 4 depicts the authentication process of the members in the social network;

FIG. 5a is a flowchart for restricting the access of data in social network within the primary contact;

FIG. 5b is a flowchart for restricting the access of the data in social network outside the primary contact;

FIG. 6 is a flowchart for analyzing data in the social network;

FIG. 7 depicts the emergency service available in the social network.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure provide a system and method for sharing the medical data in a social network where the access of the personal information, such as clinical data, is restricted and data privacy is maintained. The disclosure also provides the system and method of data analysis by the members of the social network and also by the researcher using the social network's medical database. In addition, the system and method provides the emergency service to its members to send the alert message in case of emergency.

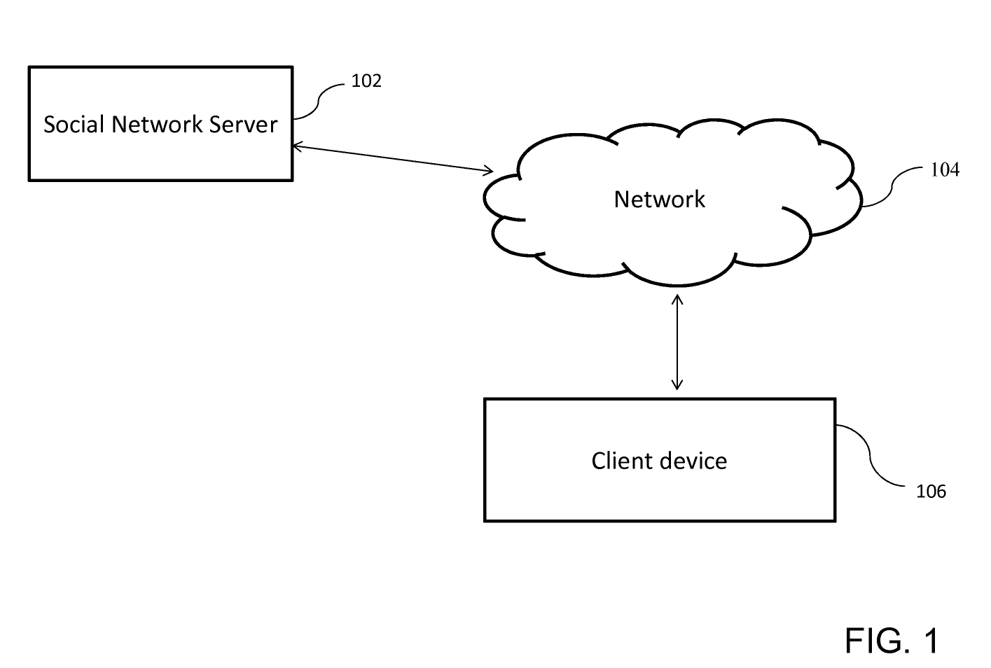

FIG. 1 illustrates an exemplary environment of an online social network. According to the illustration in FIG. 1, a social network server 102 is connected to a client device 106 over a computer network 104. The network 104 can be any network over which information can be transmitted between devices such as internet, intranet, Virtual Private Network (VPN), Local Area Network (LAN), Wide Area Network (WAN) and the like. A client device 106 may include, but is not limited to, a desktop computer, a laptop, a mobile computing device and the like.

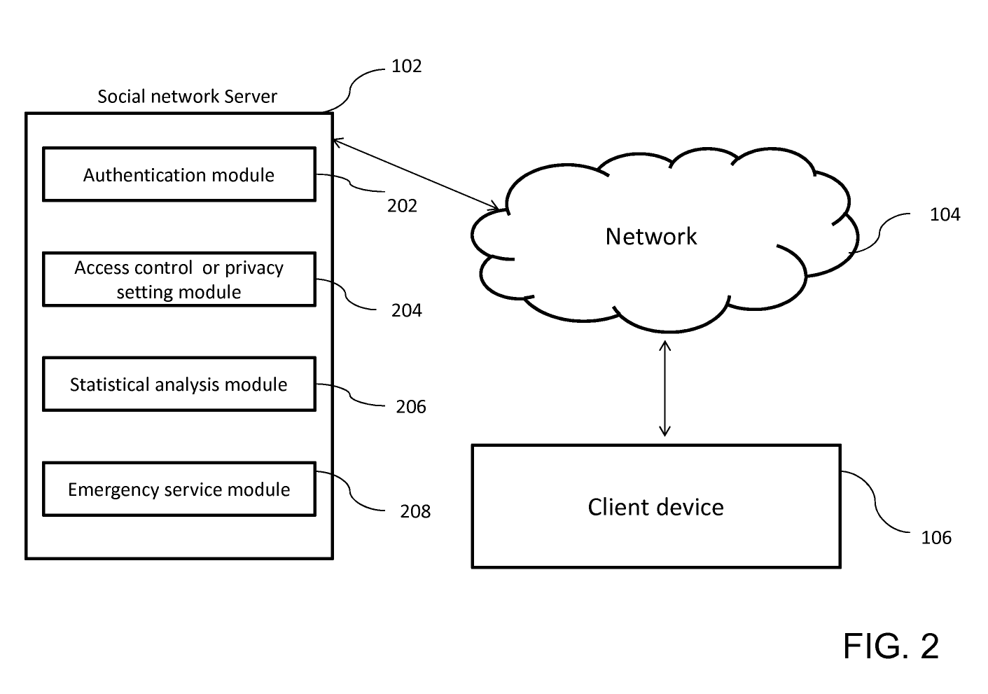

FIG. 2 depicts an exemplary environment of an online social network along with various modules for sharing and analyzing medical data in the social network. More particularly, in FIG. 2 the social network server 102 includes an authentication module 202 configured to authenticate one or more members of the social network and helps to create an authentic source of medical database that can be made available for research and analytics. The social network server 102 also includes an access control or privacy setting module 204 which ensures the data privacy of the members of the social network. Access control or privacy setting module 204 restricts the visibility of the data entered by a particular member to other members. Access control or privacy setting module 204 can be configured for each primary level contact and also for second and third level contacts. The server 102 also includes a statistical analysis module 206 which helps one or more members and nonmember researchers to run the statistical analysis of data available in the social network. Nonmember researcher can login to the Researcher's analysis platform and run statistical analysis of medical data available in social network. According to one embodiment of the invention the social network server 102 includes an emergency service module 208 which helps the members of the social network to contact with one or more medical professionals in case of emergency situation. Members need to subscribe to avail the emergency service.

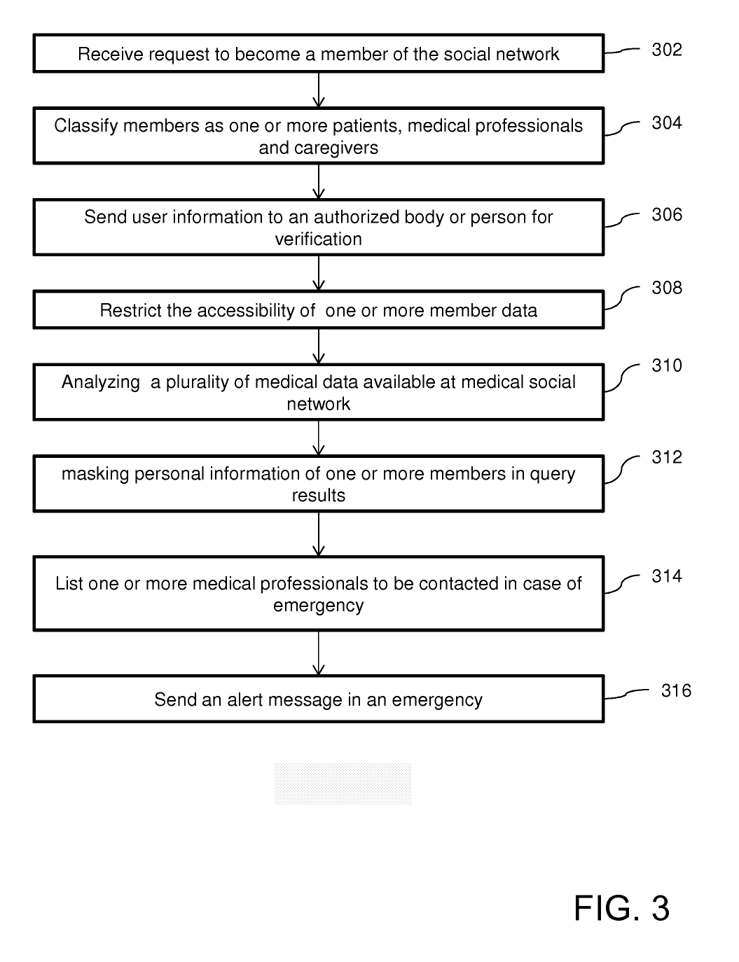

FIG. 3 is a flowchart for sharing, analyzing and consolidating medical data in a social network, in accordance with an embodiment of the present invention. The method includes, receiving the request of the participants to become a member of the social network, at 302. Thereafter, at 304, the participants are classified as patients, medical professionals and caregivers. After classifying the participants, at 306, the system sends the user information to authorized body for verification. If the participants are not authorized as genuine user by the authorized body then the service is not available to them. If the participants are authenticated by the authentication body as genuine user then the participants are allowed to login to the server as a member and they need to enter the data regarding their personal information as well as clinical data or experience and specialization in a pre-existing template. After login, at 308, members are required to configure access control settings to restrict the accessibility of the member data. The members can configure access control for each individual. After that, at 310, the members can analyze the data across the primary network or across different communities or across social network based upon the query. The data analysis across the community and social network is a paid service. Data analysis is also possible for the non member researchers upon login in the Researcher's analysis platform. The system masks the personal information in the query results, at 312. After analyzing the data the members may select to login the emergency service. If the members opt for emergency service then, at 314, they have to write down the names of the contacts to be contacted in case of emergency. In accordance with an embodiment of the present invention, at 316, an alert message is sent to the specified contacts in case of emergency.

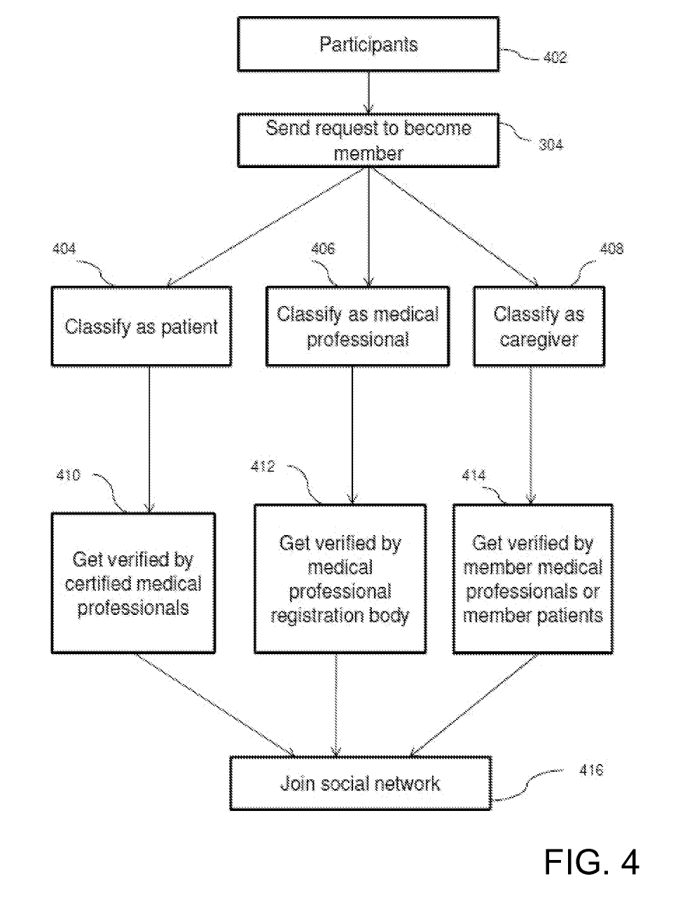

FIG. 4 depicts the authentication process of the members in the social network. As shown in the figure, the participants 402 send the request to the social network to become a member, at 304. After receiving the request the system classify the participants as patients, at 404, or as medical professionals, at 406, or as caregivers, at 408. Thereafter, at 410, the patients are verified by medical professionals by whom they are being advised. The medical professionals are verified by a medical professional registration body upon request and they verify the personal details submitted by the medical professionals, at 412. Further, at 414, caregivers are verified by member medical professionals or member patients. After getting verified, at 416, the members can join the social network.

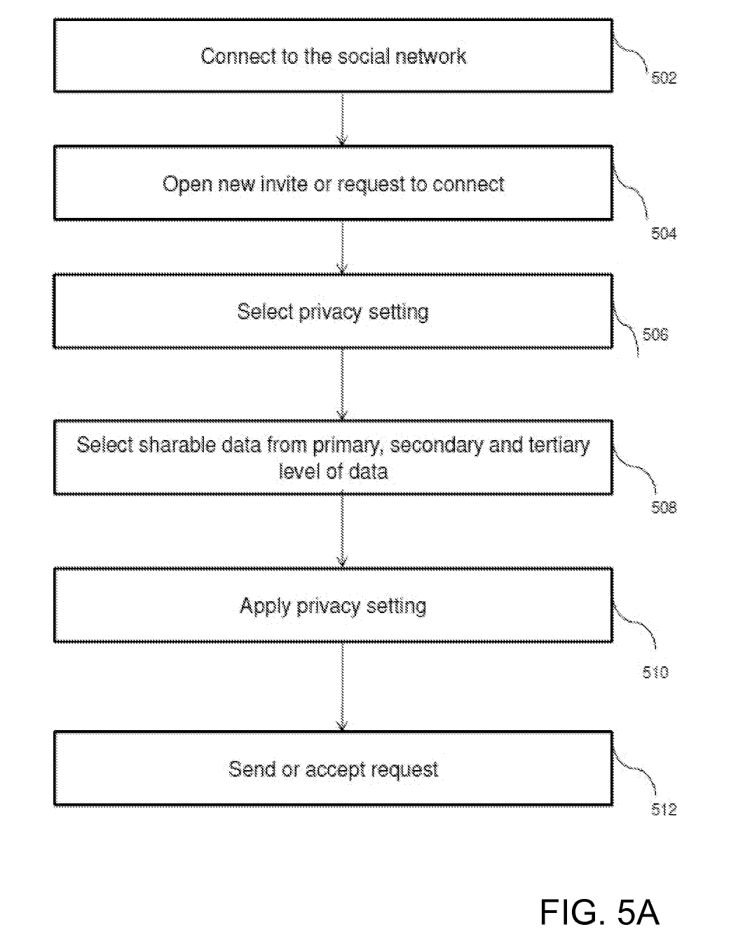

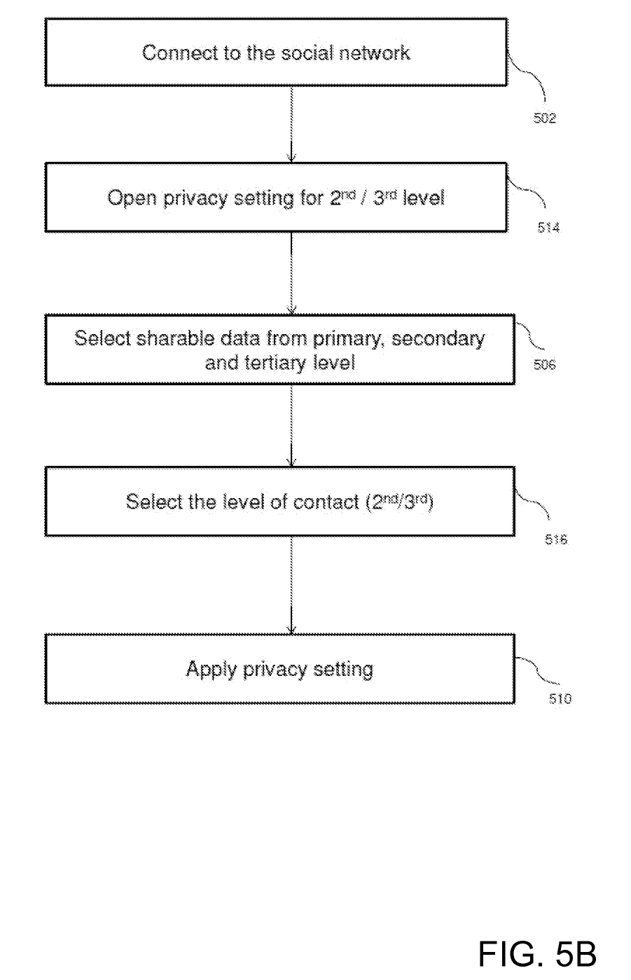

According to an embodiment of the present invention the members can set the access control of data associated with them for individuals of primary contact as well as for second and third level contacts. In this system access control settings with respect to every connection are set at the time of establishing the contact. Access control settings are a part of the connection procedure. FIG. 5a is a flowchart for restricting the access of data in social network for individual in primary contact. In step 502, the members connect to the social network. In step 504, the member opens new invite or opens request to connect sent by another member. In step 506, the members are required to select the privacy setting option. In step 508, the members select the data which they want to share with a particular contact. Only those data are visible by the contacts which are permitted by the members. The data associated with a member is divided into three data levels such as primary data, secondary data and tertiary data. The primary data includes the name and place of a member; secondary data includes more specific information such as address, email, phone number and primary health concern in case of member patients or specialization in case of member medical professionals; tertiary data includes more critical information such as, the clinical data in case of member patients, personal recommendations and experiences in case of member medical professionals and member caregivers. The clinical data is put on specific templates designed by experts so that the data gathered has a uniform structure.

If any member does not select a particular data from primary, secondary or tertiary level for sharing with a particular contact then that contact cannot see that data of the member. In step 510, the members are required to apply the access control or privacy setting they have configured for a particular contact. In step 512, the members send the friend request or accept the friend request subject to the access control configuration.

FIG. 5b is a flowchart for restricting the access of the data in social network outside the primary contact. As the figure shows, in step 502, the members connect to the social network. In step 514, the members open the privacy setting for second and third level contacts. Thereafter, in step 506, members select the data from the primary, secondary and tertiary level that can be shared with the contacts in second or third level contacts. In step 516, members select the contact level such as second contact level and third contact level. In step 510, members are required to apply privacy setting.

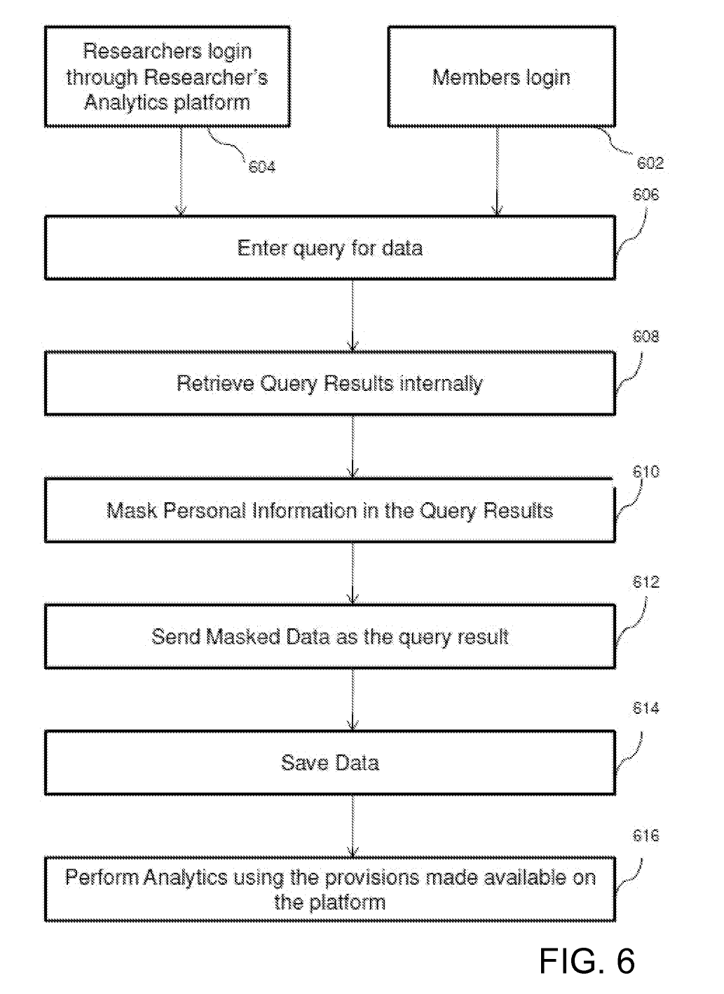

FIG. 6 is a flowchart for analyzing data in the social network. To start with, at 602, the members login to the social network. If any researcher who is not the member of the social network want to access the data available in the social network can access the data by login into the researcher's analytics platform after paying the subscription fee, at 604. After login in to the system the members or researchers enter the data query, at 606. Data analysis uses the data available in the primary contact level as well as data available across any community and social network. If the member uses the community or social network data outside the primary contact level they are required to pay the fees for that. The queries include but not limited to list queries, number queries, and percentage queries. In list queries the list containing names or data values pertaining to the parameter of interest is displayed; in number queries the number of instances matching with the query is displayed; in percentage queries the percentage of the matching instances in the data is displayed. To aid basic statistical research the basic statistical parameters such as average, mean, median or variation are supported in the queries. In step 608, the system retrieves the query results but this result is not displayed to the members or researchers. The data is displayed to the members or researchers only after masking the personal information in the query results, at 610. The basic idea is to mask the information if the data sought pertains to personal identity. The masked data is sent to the members as the query result, at 612. In the masked data personal information is replaced by false personal data. The data is masked by using various masking techniques commonly known by an ordinary person skilled in the art. As above various examples of masking techniques may include, but not limited to, shuffling, encryption, and substitution. Shuffling may have various schemes, for example, every “A” with “Z” or every “Z” with “A”. In encryption there is encryption logic for changing every value under the sensitive information. Substitution may have various schemes, for example, replacing all “A”s with “K”s. Masking techniques may be reversible, dynamic, selective or incremental. In step 614, the members or researchers saved the query result and in step 616, they perform the analytics using the capabilities of the research bench or transport to suitable research tool. (Important to mention that the code used to mask is unknown to the user)

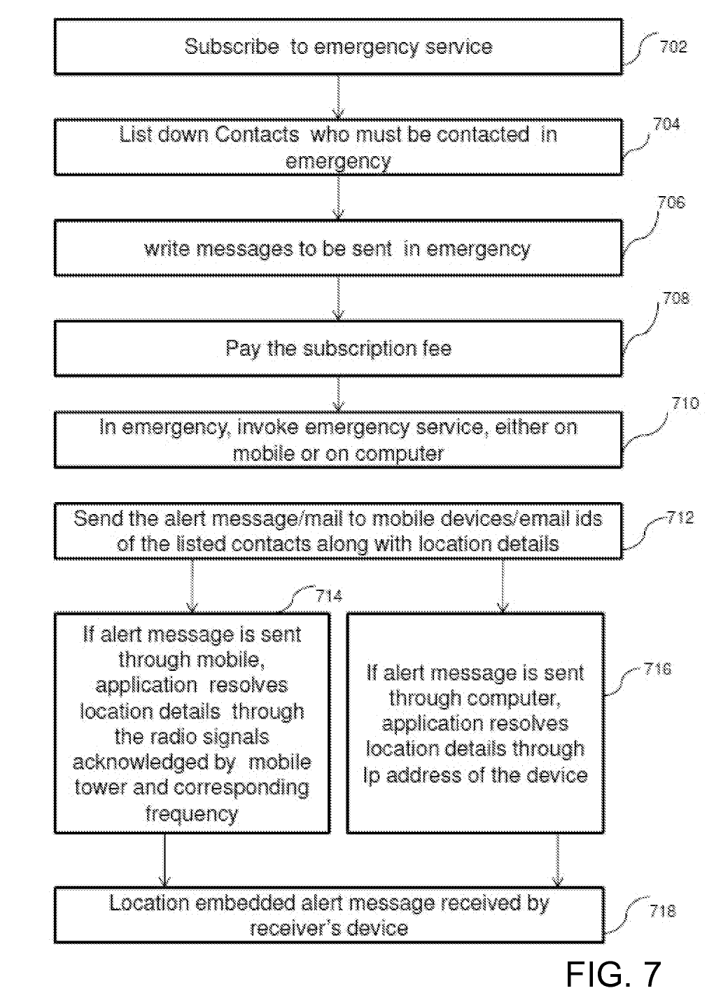

FIG. 7 depicts the emergency service in the social network. In step 702, the members subscribe for emergency service. In step 704, the members list down the contacts who must be contacted in case of emergency. Here, the members should write the name and contact information such as phone number, email of the person. In step 706, the members are required to write messages to be sent in case of emergency to the specified contacts. In step 708, the members pay the subscription fee.

In step 710, the members invoke emergency service in case of emergency situation either on mobile or on computer. In the step 712, the members send the alert message just by clicking the emergency button to mobile devices or email ids of the specified contacts along with location details. If the alert message is sent through mobile, at 714, then the application resolves location details through the radio signals acknowledged by mobile tower and corresponding frequency. If alert message is sent through computer, at 716, application resolves location details through Ip address of the device. In the step 718, the location embedded alert message received by receiver's device.

### Non-Transitory Computer-Readable Media

Any of the computer-readable media herein can be non-transitory (e.g., volatile or non-volatile memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

We claim:

1. A system for sharing, analyzing and consolidating medical data in a social network comprising:
an authentication module configured to verify one or more data associated with one or more participants applied to become a member in the medical social network;
means for configuring access control, whereby the accessibility of data associated with a member of the social network is restricted;
a statistical analytics module; and
means for providing an emergency service comprising:
listing names of one or more medical professionals to be contacted in case of emergency; and
sending an alert message to the medical professionals.

2. The system for sharing, analyzing and consolidating medical data in a medical social network as claimed in claim 1, wherein one or more participants are classified into patients, medical professionals and caregivers.

3. The system for sharing, analyzing and consolidating medical data in a medical social network as claimed in claim 1, wherein the authentication module is configured to send a request for verification to a medical professional registration body, one or more certified medical professionals, one or more member patients or member medical professionals.

4. The system for sharing, analyzing and consolidating medical data in a medical social network as claimed in claim 1, wherein a set of data associated with a member of the medical social network comprises primary data, secondary data and tertiary data.

5. The system for sharing, analyzing and consolidating medical data in a medical social network as claimed in claim 4, wherein the primary, secondary and tertiary data are accessible by one or more members of the medical social network based on the access control configuration of the member.

6. The system for sharing, analyzing and consolidating medical data in a medical social network as claimed in claim 4, wherein the primary data comprises name and place of one or more members of the medical social network.

7. The system for sharing, analyzing and consolidating medical data in a medical social network as claimed in claim 4, wherein the secondary data comprises address, email, phone number, primary health information and specialization.

8. The system for sharing, analyzing and consolidating medical data in a medical social network as claimed in claim 4, wherein the tertiary data comprises clinical data, personal recommendations and experiences.

9. The system for sharing, analyzing and consolidating medical data in a medical social network as claimed in claim 1, wherein data associated with a member of the social network further includes information regarding one or more activities of the member of the social network.

10. The system for sharing, analyzing and consolidating medical data in a medical social network as claimed in claim 1, wherein the statistical analytics module is available to one or more members of the social network and non-member researchers to run statistical analysis of medical data available in the social network.

11. The system for sharing, analyzing and consolidating medical data in a medical social network as claimed in claim 1, wherein the statistical analytics module masks one or more personal information about one or more members of the social network in one or more query results.

12. The system for sharing, analyzing and consolidating medical data in a medical social network as claimed in claim 1, wherein the alert message is sent to a message inbox of one or more medical professionals by clicking an emergency button.

13. The system for sharing, analyzing and consolidating medical data in a medical social network as claimed in claim 1, wherein the alert message also includes location information of at least one device used to send the alert message

14. A computer implemented method for sharing, analyzing and consolidating medical data in a social network comprising:
receiving a request to become a member of the social network;
classifying one or more participants as patients, medical professionals and caregivers;
verifying data associated with one or more participants by sending the data to a medical professional registration body, one or more certified medical professionals, one or more member patients or one or more member medical professionals;
restricting accessibility of data associated with a member of the social network to one or more contacts in the social network;
analysing a plurality of medical data available at the social network;
masking one or more personal information of one or more members of the social network in one or more query results;
listing names of one or more medical professionals to be contacted in case of emergency; and
sending an alert message to one or more medical professionals in case of an emergency.

15. The computer implemented method for sharing, analyzing and consolidating medical data in a medical social network as claimed in claim 13, wherein a set of data associated with a member of the medical social network comprises primary data, secondary data and tertiary data.

16. The computer implemented method for sharing, analyzing and consolidating medical data in a medical social network as claimed in claim 14, wherein the primary, secondary and tertiary data are accessible by one or more members of the medical social network based on the access control configuration of the member.

17. The computer implemented method for sharing, analyzing and consolidating medical data in a medical social network as claimed in claim 14, wherein the primary data comprises name and place of one or more members of the social network.

18. The computer implemented method for sharing, analyzing and consolidating medical data in a medical social network as claimed in claim 14, wherein the secondary data comprises address, email, phone number, primary health information of one or more member patients and specialization of one or more medical professionals and caregivers.

19. The computer implemented method for sharing, analyzing and consolidating medical data in a medical social network as claimed in claim 14, wherein the tertiary data comprises clinical data of one or more member patients, personal recommendations and experiences of member medical professionals and caregivers.

20. The computer implemented method for sharing, analyzing and consolidating medical data in a medical social network as claimed in claim 13, wherein the statistical analysis is available to one or more members of the social network and non-member researchers.

21. The computer implemented method for sharing, analyzing and consolidating medical data in a medical social network as claimed in claim 13, wherein the alert message is sent to a message inbox of one or more medical professionals by clicking an emergency button of an emergency service of the social network.

22. The computer implemented method for sharing, analyzing and consolidating medical data in a medical social network as claimed in claim 13, wherein the alert message also includes location information of at least one device used to send the alert message.
